(19) United States
(12) Patent Application Publication
(10) Pub. No.: US 2019/0389711 A1
(43) Pub. Date: Dec. 26, 2019

(54) REMOVABLE NEOPRENE SLEEVE FOR A JOCKEY BOX COOLER

(71) Applicant: David Coplin, Huntington Beach, CA (US)

(72) Inventor: David Coplin, Huntington Beach, CA (US)

(21) Appl. No.: 16/017,832

(22) Filed: Jun. 25, 2018

(51) Int. Cl. B67D 1/08; B65D 25/28; B65D 43/16

(52) U.S. Cl. CPC B67D 1/08; B67D 2001/0095; B65D 43/162; B65D 25/2841

(57) ABSTRACT

In accordance with one aspect of the invention, a neoprene sleeve is provided that is sized to fit a jockey box cooler so that the sleeve extends between the bottom end of the container and the top of the container. The neoprene sleeve is resilient and covers the outer finish of the container, thereby protecting the container by inhibiting (e.g., preventing) dents and scratches to the outer surface of the container while covering up any existing dents and scratches so that they are not noticeable to the user.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57, and should be considered a part of this specification.

### BACKGROUND

### Field

The invention relates to jockey box cooler containers, and more particularly to removable sleeves for jockey box cooler containers.

### Description of the Related Art

Jockey box coolers are portable coolers commonly used to dispense a cold beverage, such as beer. The cooler has connectors on a rear surface to connect to the beer keg and/or CO2 container, connectors on a front surface to connect with dispensing spigots/handles to dispense the fluid, and coils within the cooler through which the liquid passes from the rear connectors to the front connectors. The cooler can be filled with ice to cool the liquid as it flows through the coils so the liquid dispensed using the spigots is cold.

Such containers are usually made of plastic. However, the containers can become dented or scratched during use, which makes them less attractive to use (e.g., at a catering event, in a social setting), even while the container may still be operable to dispense liquid and the internal portion of the container remains intact.

### SUMMARY

Accordingly, there is a need to protect existing jockey box containers by inhibiting (e.g., preventing) the container from being dented or scratched during use and also covering up any existing dents or scratches on the container, thereby extending the working life of the container and therefore decreasing potential impact on landfill from disposal of dented and unsightly containers.

In accordance with one aspect of the invention, a neoprene sleeve is provided that is sized to fit a jockey box cooler so that the sleeve covers the sides and lid of the container. Optionally, the sleeve does not cover the bottom surface of the container. Optionally, the portion of the sleeve that covers the lid is one piece with (e.g., attached to) the portion of the sleeve that covers the side walls of the container. Optionally, the sleeve has a fastener (VELCRO® strip) attached to the lid portion of the sleeve and a fastener (VELCRO® strip) attached to an inner surface of the side wall sleeve portion, where the fasteners can attach to each other when the lid is in the closed position, and the fasteners can be concealed when the lid is open (e.g., hidden between the outer surface of the cooler body or cooler lid and the inner surface of the sleeve attached to said cooler body or cooler lid).

The portion of the sleeve that covers the side walls of the container has a pair of openings on a front surface that can allow the front connectors of the jockey box cooler to extend therethrough to conned with the dispensing spigots/handles, and ha a pair of openings on the rear surface to allow the rear connectors of the jockey box cooler to extend therethrough to connect to the keg or CO2 dispenser. The portion of the sleeve that covers the side walls also has a pair of side openings to allow the handles of the cooler to extend therethrough. The neoprene sleeve is resilient and covers the outer finish of the container, thereby protecting the container by inhibiting (e.g., preventing) dents and scratches to the outer surface of the container while covering up any existing dents and scratches so that they are not noticeable to the user.

In accordance with another aspect of the invention, a sleeve is provided that is sized to fit a jockey box cooler so that the sleeve extends between the bottom end of the container and the lid of the container (e.g., covers the sidewalls of the container body and the lid of the container). The sleeve is of a resilient material and covers the outer finish of the container, thereby protecting the container by inhibiting (e.g., preventing) dents and scratches to the outer surface of the container while covering up any existing dents and scratches so that they are not noticeable to the user.

In accordance with another aspect of the invention, in combination are provided a jockey box cooler for dispensing a beverage and a removable sleeve of resilient material configured to resiliently fit over an outer surface of the container to thereby protect the container from suffering dents, scratches or nicks. The sleeve is also configured to camouflage existing dents, nicks and scratches on the container, the sleeve having a portion that covers the lid of the cooler, and a sidewall portion that covers the sidewalls of the cooler. The sleeve does not cover the bottom surface of the cooler. Optionally, an elastic strip extends between one side and an opposite side of the sleeve across the bottom surface of the cooler. The portion of the sleeve that covers the side walls of the container has a pair of openings on a front surface that can allow the front connectors of the jockey box cooler to extend therethrough to conned with the dispensing spigots/handles, and ha a pair of openings on the rear surface to allow the rear connectors of the jockey box cooler to extend therethrough to connect to the keg or CO2 dispenser. The portion of the sleeve that covers the side walls also has a pair of side openings to allow the handles of the cooler to extend therethrough. Optionally, the sleeve is made of neoprene.

In accordance with one aspect, a jockey box container for use in dispensing a beverage and a removable sleeve of resilient material configured to resiliently fit over an outer surface of the container body and over a lid of the container are provided in combination. The sleeve protects the container from suffering dents, scratches or nicks and is also configured to cover existing dents, nicks and scratches on the container. The sleeve has a body portion extending between a bottom edge that defines an open bottom end and a top edge that defines an open top end, the body portion having a pair of openings on opposite sides of the body configured to receive a pair of handles of the container. The body portion also has a first pair of openings on a front surface configured to resiliently receive a pair of connectors on a front surface of the container. The body portion also has a second portion of openings on a rear surface configured to resiliently receive a pair of connectors on a rear surface of the container. The lid portion is attached to the body portion of the sleeve via a seam. When attached over the container, the bottom edge of the body portion is spaced above a bottom surface of the container and the top edge of the body portion is substantially aligned with a top edge of a chamber of the container.

In accordance with another aspect, a removable sleeve for use with a jockey box cooler is provided. The sleeve comprises a sleeve body of a single layer of neoprene where the edges of said layer are joined together by a hot weld seam that extends from a bottom edge to a top edge of the body. The sleeve body has a rectangular shape with an open top end and an open bottom end. A pair of openings on a front surface of the body are configured to resiliently receive therethrough a pair of connectors on a front surface of the cooler. A pair of openings on a rear surface of the body are configured to resiliently receive therethrough a pair of connectors on a rear surface of the cooler. A pair of opposite side openings are configured to receive handles of the cooler therethrough. The sleeve also comprises a lid body attached to the sleeve body via a seam that extends along a junction between the rear surface of the body and a rear edge of the lid body. The lid body is configured to fit over a lid of the container. The lid body has a connector attached to an inner front surface of the lid body that is configured to releasably engage a connector on an inner front surface of the sleeve body when a front end of the lid body is in a closed position adjacent the front surface of the sleeve body. The sleeve body is configured to removably and resiliently fit over the jockey box cooler so that the bottom edge of the sleeve body is disposed above a bottom surface of the cooler and so that the top edge of the sleeve body is substantially aligned with a top edge of a chamber of the cooler. The sleeve body is configured to protect the container from suffering dents, scratches or nicks and also configured to cover existing dents, nicks and scratches on the container.

### BRIEF DESCRIPTION OF THE DRAWINGS

FIG. 1 is a top perspective view of one embodiment of a jockey box cooler with a removable sleeve with the sleeve resiliently mounted on the jockey box cooler, the lid in the closed position;

FIG. 2 is a top perspective view thereof with the lid in the open position, showing coils in the jockey box cooler;

FIG. 3 is a top perspective view thereof with the lid in the closed position showing handles and spigots.

FIG. 4 is a front view thereof;

FIG. 5 is a rear view thereof;

FIG. 6 is a left-side view thereof;

FIG. 7 is a right-side view thereof;

FIG. 8 is a top view thereof;

FIG. 9 is a bottom view thereof;

### DETAILED DESCRIPTION

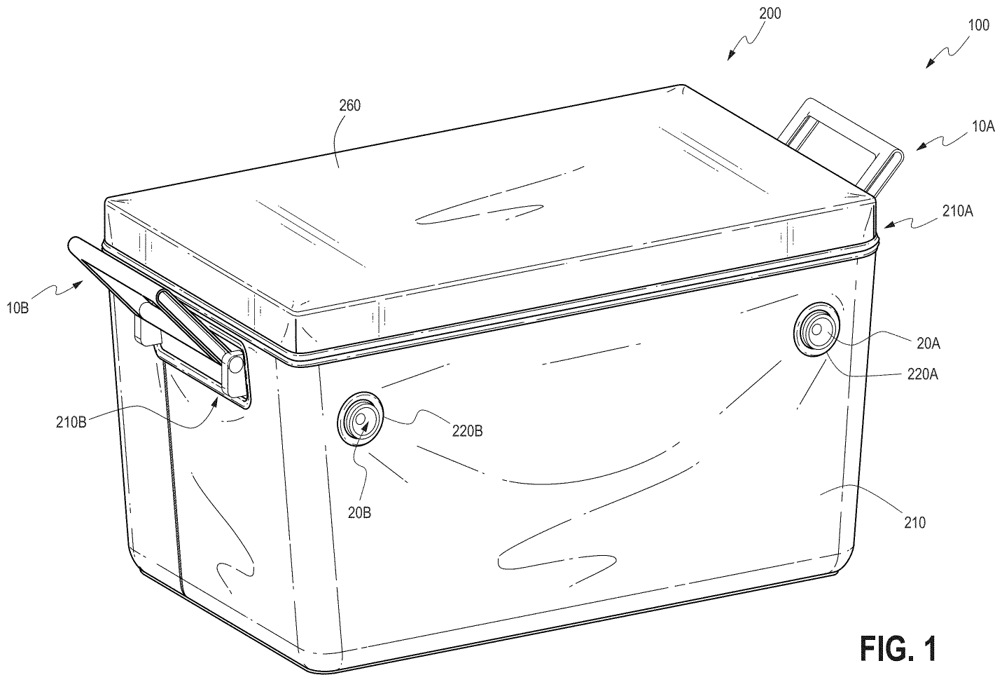

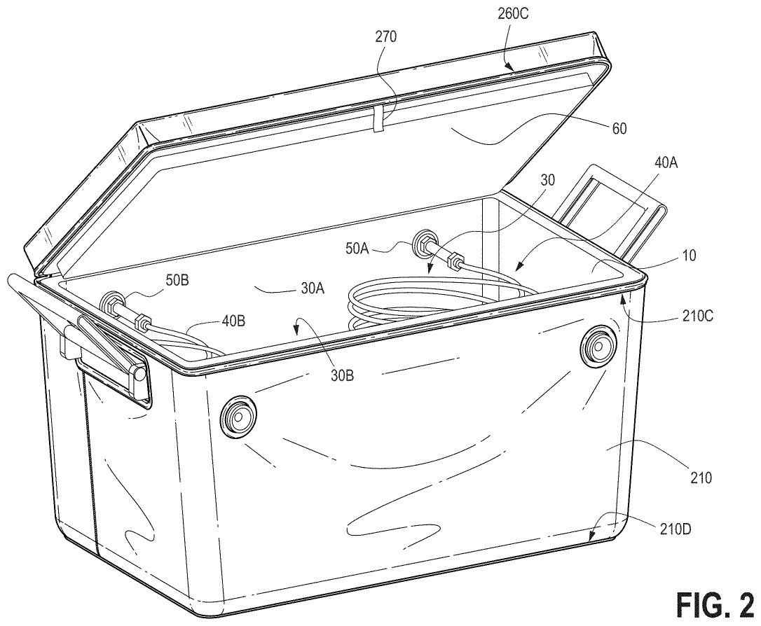

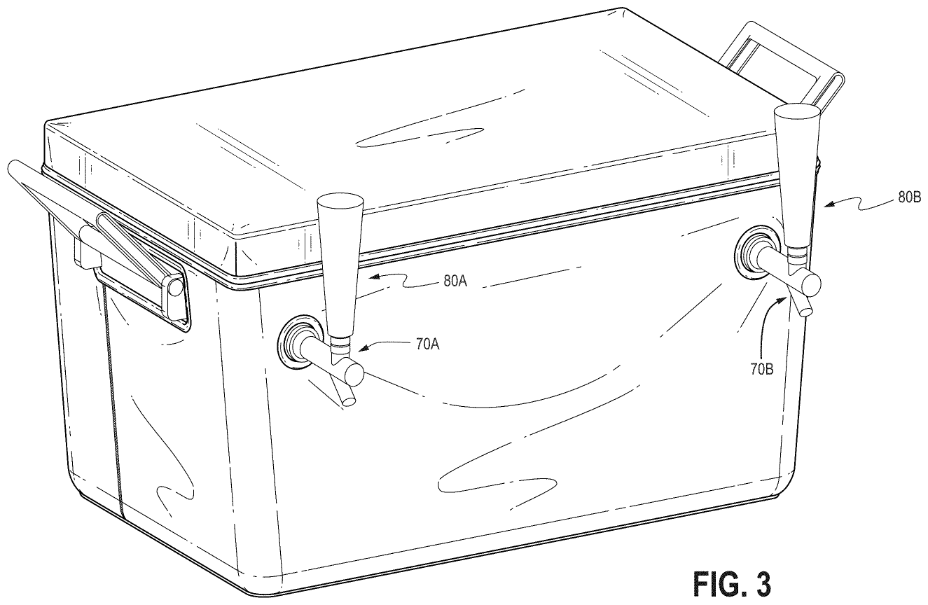

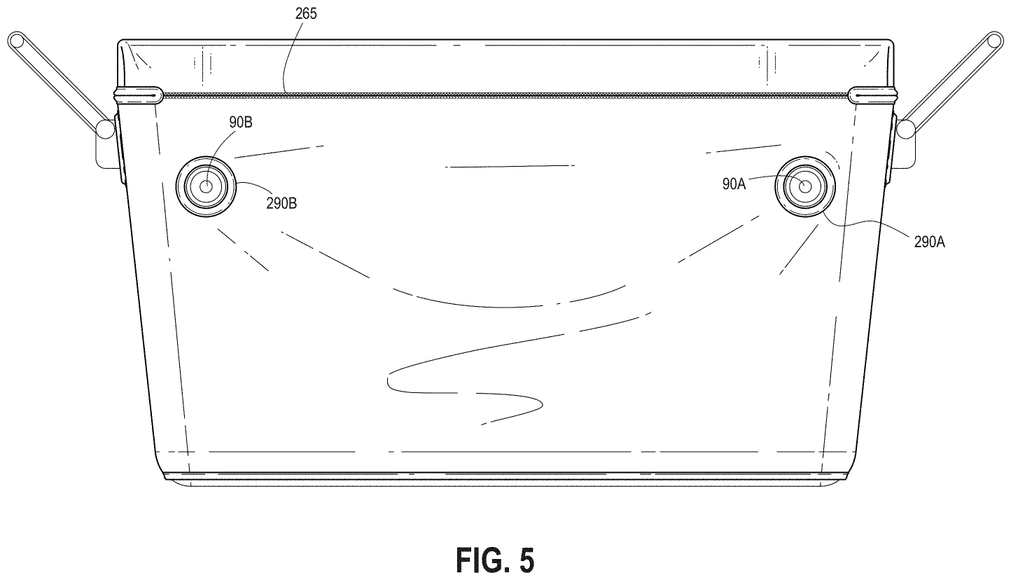

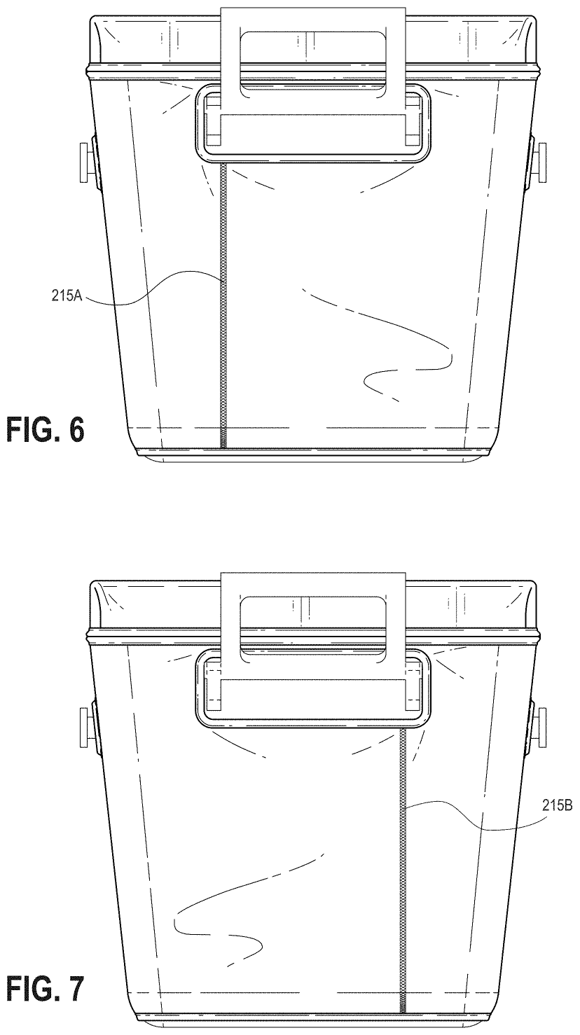

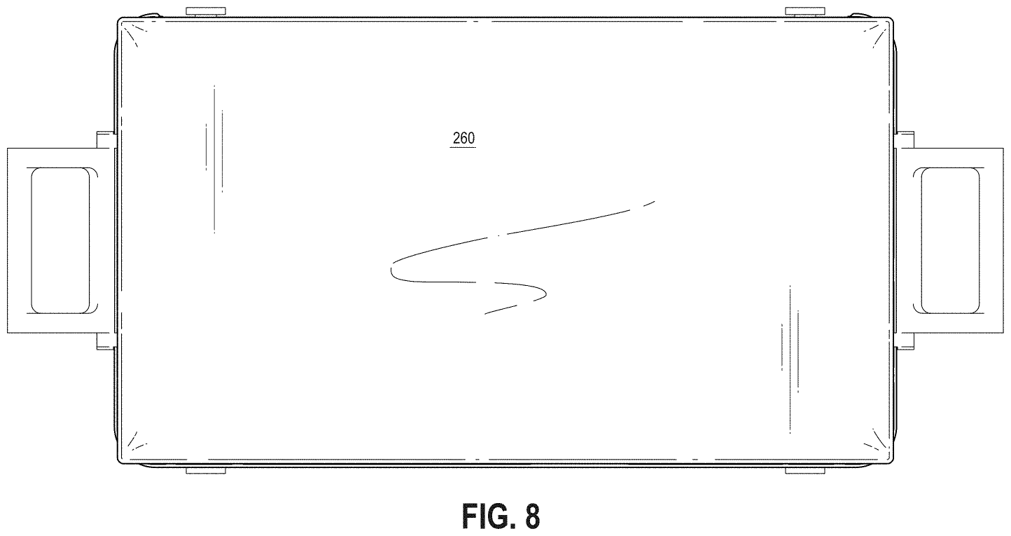

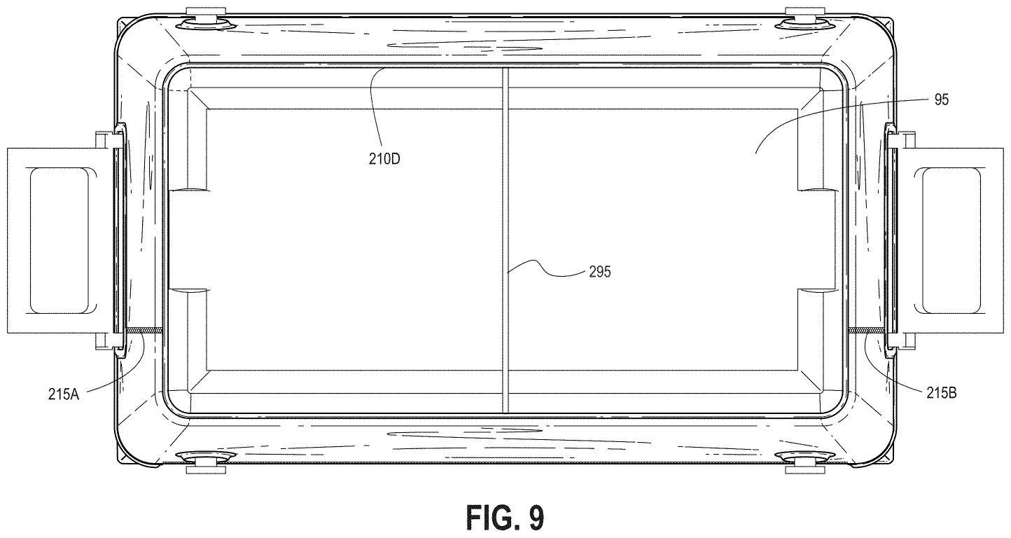

FIGS. 1-9 show a sleeve 200 mounted on a jockey box cooler container 100. The cooler 100 can have a body 10 with a pair of handles 10A, 10B, and a lid 60 that can be at least partially lifted off the body 10 to access a chamber 50 in the body 10. The chamber 30 can house one or more coils 40A, 40B. The coils 40A, 40B can connect to connectors 50A, 50B on a rear surface 30A of the chamber 30, and can connect to connectors 20A, 20B on a front side 30B of the chamber 30. The connectors 50A, 50B can connect to connectors 90A, 90B on a rear surface of the body 10. A pair of spigots 70A, 70B can connect to the connectors 20A, 20B, and handles 80A, 80B can movably connect to the spigots 70A, 70B. The handles 80A, 80B can be selectively actuated to allow or disallow flow through the spigots 70A, 70B (e.g., to dispense a beverage therefrom). In operation, a beverage source (e.g., kegs of beer) are coupled to the rear connectors 90A, 90B, and the chamber 30 is optionally filled with ice. The beverage flows from the beverage source through the coils 40A, 40B to the front connectors 20A, 20B and spigots 70A, 70B, and the beverage can be dispensed from the spigots 70A, 70B when the handles 80A, 80B are actuated. Advantageously, the coils and ice allow the beverage to be cooled within the chamber 30 before being dispensed via the spigots 70A, 70B.

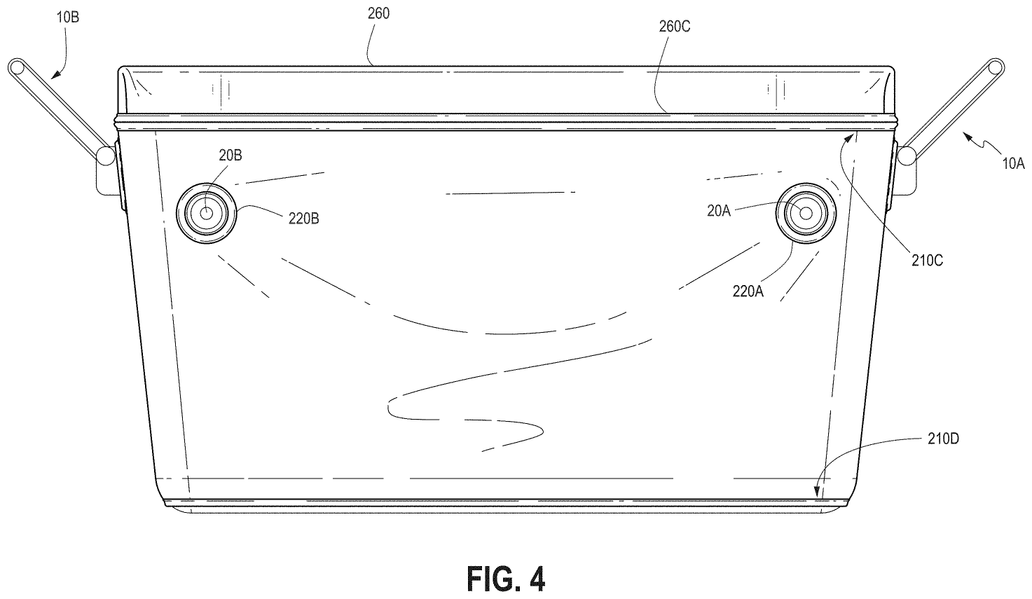

The sleeve 200 can be removably disposed on at least a portion of the body 10. The sleeve 200 can have openings 210A, 210B on sides of the sleeve 200 through which the handles 10A, 10B can pass. The sleeve 200 can also have openings 220A, 220B on a front surface of the sleeve 200 through which the front connectors 20A, 20B can pass, and can have openings 290A, 290B through which the rear connectors 90A, 90B can pass. The sleeve 200 can have a body portion that extends from a bottom edge 210D to a top edge 210C. The bottom edge 210D is located above the bottom surface of the container 100 (see FIG. 4) and the top edge 210C is substantially aligned with a top edge of the chamber 30 when the sleeve 200 is on the container 100. The sleeve 200 has a lid portion 260 that resiliently fits over the lid 60 of the cooler 100. A connector (e.g., VELCRO® portion) 270 is attached to the lid portion 260 and can removably fasten to a corresponding connector on the body portion 210 of the sleeve 200 (e.g., on a surface of the body portion 210 facing the body 10 of the container 100. The lid portion 260 is attached to the body portion 210 by a seam 265. A strap 295 extends across a bottom surface 95 of the container 100 and attaches to opposite portions of the bottom edge 210D.

The sleeve 200 can be made of a resilient material, such as neoprene. The sleeve 200 can be generally rectangular with dimensions substantially equal to the dimensions of the container 100. In one embodiment, the thickness t of the sleeve 200 can be between about 1/16 in. and about ½ in., such as about ⅛ inches. The sleeve 20 can be made of a single layer of resilient material, such as neoprene, with a seam (e.g. hot weld seam) 215A, 215B joining the edges of said single layer of material.

Advantageously, when placed on the container 100, the sleeve 200 protects the body 10 and lid 60 of the container 100 and inhibits (i.e., prevents) dents, nicks, chips or scratches to the body 10, as well as covers or camouflages any existing dents, nicks or scratches on the body 10 of the container 10, thereby extending the working life of the container 10 and therefore decreasing potential impact on landfill from disposal of dented and unsightly bottles. Therefore, the sleeve 200 advantageously protects the container 100 from dents, scratches and nicks. In one embodiment, the resilient nature of the sleeve 200 can allow the sleeve 200 to cover up any existing dents on the container 100 while presenting a generally smooth outer surface to the user, such that the user does not notice the existing dents on the container 100. Additionally, the resilient nature of the sleeve 200 allows the sleeve 200 stretch over at least a portion of the body 10 of the container 100, thereby allowing the sleeve 200 to fit dispensers of various outer dimensions and shapes of jokey box containers. The outer surface of the sleeve 200 can be substantially smooth (e.g., continuous), such that the sleeve 200 presents a smooth outer surface (e.g., cylindrical outer surface) to the user when fitted over the body 10 of the container 100.

Advantageously, the sleeve 200 is removable, which allows the sleeve 200 to be changed out and replaced (e.g., when the user wants to wash the sleeve 200, or when the user wants to change the sleeve depending on the artwork shown on the surface of the sleeve 200).

The sleeve 200 can include one or more insignias that can be displayed on an outer surface of the sleeve 200, therefore allowing the use of the sleeve for advertisement purposes (e.g., to show the name or logo of the company where the water cooler is used). The one or more insignias can be printed on the surface of the sleeve 200 (e.g., via a sublimation printing process, screen printing process, etc.).

In embodiments where the container 100 is made of plastic, the sleeve 200 can protect the container 100 from dents, scratches, chips and nicks. Additionally, in the event of the container 100 cracking or breaking, the sleeve 200 can advantageously help retain the broken pieces within the sleeve 200, thereby inhibiting the spreading of said broken pieces across a floor surface where the pieces may pose a cutting risk to others as well as facilitating the cleanup of the broken container 100.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the heated or cooled drinkware need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed containers.

What is claimed is:

1. In combination, a jockey box container for use in dispensing a beverage and a removable sleeve of resilient material configured to resiliently fit over an outer surface of the container body and over a lid of the container to thereby protect the container from suffering dents, scratches or nicks and also configured to cover existing dents, nicks and scratches on the container, the sleeve having a body portion extending between a bottom edge that defines an open bottom end and a top edge that defines an open top end, the body portion having a pair of openings on opposite sides of the body configured to receive a pair of handles of the container, the body portion also having a first pair of openings on a front surface configured to resiliently receive a pair of connectors on a front surface of the container, the body portion also having a second portion of openings on a rear surface configured to resiliently receive a pair of connectors on a rear surface of the container, the lid portion attached to the body portion of the sleeve via a seam, wherein when attached over the container, the bottom edge of the body portion being spaced above a bottom surface of the container and the top edge of the body portion being substantially aligned with a top edge of a chamber of the container.

2. The combination of claim 1, wherein the sleeve is a neoprene sleeve.

3. The combination of claim 2, wherein the sleeve is made of a single layer of material joined together at a seam.

4. The combination of claim 3, wherein the seam is a hot weld seam.

5. The combination of claim 1, further comprising a strap that extends across the bottom surface of the container and attaches to opposite sides of the bottom edge of the body portion.

6. The combination of claim 1, wherein the sleeve is configured to fit over a jockey box container with a body that is at least partially rectangular.

7. The combination of claim 6, wherein the sleeve presents a substantially smooth outer surface to a user when fitted over the container.

8. A removable sleeve for use with a jockey box cooler, comprising:
a sleeve body of a single layer of neoprene where the edges of said layer are joined together by a hot weld seam that extends from a bottom edge to a top edge of the body, the sleeve body having a rectangular shape with an open top end and an open bottom end, a pair of openings on a front surface of the body configured to resiliently receive therethrough a pair of connectors on a front surface of the cooler, a pair of openings on a rear surface of the body configured to resiliently receive therethrough a pair of connectors on a rear surface of the cooler, and a pair of opposite side openings configured to receive handles of the cooler therethrough,
a lid body attached to the sleeve body via a seam that extends along a junction between the rear surface of the body and a rear edge of the lid body, the lid body configured to fit over a lid of the container, the lid body having a connector attached to an inner front surface of the lid body that is configured to releasably engage a connector on an inner front surface of the sleeve body when a front end of the lid body is in a closed position adjacent the front surface of the sleeve body,
the sleeve body configured to removably and resiliently fit over the jockey box cooler so that the bottom edge of the sleeve body is disposed above a bottom surface of the cooler and so that the top edge of the sleeve body is substantially aligned with a top edge of a chamber of the cooler, the sleeve body configured to protect the container from suffering dents, scratches or nicks and also configured to cover existing dents, nicks and scratches on the container.

9. The sleeve of claim 8, wherein the sleeve body is configured to fit over a jockey box cooler having a body that is at least partially rectangular.

10. The sleeve of claim 8, wherein the sleeve body presents a substantially smooth outer surface to a user when fitted over the jockey box cooler.

11. The sleeve of claim 8, further comprising a strap configured to extend across the bottom surface of the container and that attaches to opposite sides of the bottom edge of the sleeve body.
